(19) United States
(12) Patent Application Publication
(10) Pub. No.: US 2016/0320798 A1
(43) Pub. Date: Nov. 3, 2016

(54) METHOD FOR PRODUCING AN ELECTRONIC DEVICE AND AN ELECTRONIC DEVICE THUS PRODUCED

(71) Applicant: NOKIA TECHNOLOGIES OY, Espoo (FI)

(72) Inventors: Xiaoyu LIU, Beijing (CN); Zhigang CHEN, Beijing (CN)

(21) Appl. No.: 15/109,809

(22) PCT Filed: Jan. 26, 2014
(86) PCT No.: PCT/CN2014/071460

§ 371 Date: Jul. 5, 2016

(51) Int. Cl. G06F 1/16; G06F 3/041

(52) U.S. Cl. CPC G06F 1/1626; G06F 3/041; G06F 1/1652; G06F 2203/04103

(57) ABSTRACT

Embodiments of the present disclosure relate to a method for producing an electronic device and an electronic device thus produced. According to an embodiment of the present disclosure, the method comprises disposing (S101) a touch sensor (220) in a form of film onto an outer surface of an inner supporting frame (210); and assembling (S102) the inner supporting frame (210) into an outer housing (230) which is at least partially transparent, wherein the touch sensor (220) is configured so that it can be activated by touching a surface of the outer housing. With embodiments of the present disclosure, the touch sensor film, which is fragile and flexible, can be easily disposed with a substantially reduced risk of being damaged and thus a nearly full touch electronic device can be achieved.

### FIELD OF THE INVENTION

Embodiments of the present disclosure generally relate to an electronic device and particularly relate to a method for producing an electronic device and an electronic device thus produced.

### BACKGROUND OF THE INVENTION

Currently, the consumer electronics are being more and more popular in our daily life, especially an electronic device combining touch input technology. To improve the electronic device and meet increasing requirements on the electronic device, the functionality of electronic device is constantly increased, for example, many efforts have been made to maximize the utility of used portion of the electronic device. “Full touch” technology was just proposed in such a case. The “full touch” means that all of surfaces of the electronic device may be designed to provide touch input on the display or icons for touching by a user, in stead of only on the display area (particularly on the front side) of the electronic device.

Generally, to achieve a “full touch” electronic device, a flexible touch sensor will be used unavoidably, which is usually in a form of film. Unfortunately, the touch sensor is so flexible and fragile that it is very easy to be wrinkled or broken during disposing it on the inner surface of a housing of the electronic device. Accordingly, it is usually a great challenge to put the touch sensor film so that it is well fitted in a 3-demension full touch electronic device and thus there is not provided a full touch electronic device yet.

### SUMMARY OF THE INVENTION

In view of the foregoing, there is a need in the art to improve the electronic device to allow the touch sensor film to be disposed easily.

To this end, the present disclosure provides a new solution for disposing a touch sensor in a form of film in the electronic device so as to solve or at least partially mitigate at least a part of problems in the prior art.

According to a first aspect of the present disclosure, there is provided a method for producing an electronic device. The method comprises disposing a touch sensor in a form of film onto an outer surface of an inner supporting frame; assembling the inner supporting frame into an outer housing which is at least partially transparent, wherein the touch sensor is configured so that it can be activated by touching or interacting with a surface of the outer housing.

In an embodiment of the present disclosure, the inner supporting frame may be in a shape of tube.

In another embodiment of the present disclosure, the inner supporting frame may be shaped to have an outer surface with smooth transitions.

In a further embodiment of the present disclosure, the outer housing may be in a shape substantially similar to that of the inner supporting frame.

In a still further embodiment of the present disclosure, the method may further comprise, before assembling the inner supporting frame into the outer housing enclosing inner electronic components including a display inside the inner supporting frame with a liquid optical clear adhesive or a polarizer disposed in a gap between the inner supporting frame and the display.

In a yet further embodiment of the present disclosure, the method may further comprise disposing a liquid optical clear adhesive or a polarizer in a gap between the inner supporting frame and the outer housing.

In a still yet further embodiment of the present disclosure, the touch sensor may be disposed on the inner supporting frame through any one of a lamination process and an inner mode label (IML) process.

According to a second aspect of the present disclosure, there is also provided an electronic device. The electronic device comprises an inner supporting frame and has a touch sensor in a form of film disposed thereon, and an outer housing which is at least partially transparent and surrounds the inner supporting frame, wherein the touch sensor is configured so that it can be activated by touching or interacting with a surface of the outer housing.

With embodiments of the present disclosure, the touch sensor film, which is fragile, flexible and easy to be broken or wrinkled, can be easily integrated into the electronic device with a substantially reduced risk of being damaged. Accordingly, according to embodiments of the present disclosure, a nearly full touch electronic device can be achieved.

### BRIEF DESCRIPTION OF THE DRAWINGS

The above and other features of the present disclosure will become more apparent through detailed explanation on the embodiments as illustrated in the description with reference to the accompanying drawings, throughout which like reference numbers represent same or similar components and wherein:

FIG. 1 schematically illustrates a flow chart of a method for producing an electronic device according to an embodiment of the present disclosure;

FIG. 2 schematically illustrates a main idea of arrangement of a touch sensor film according to an embodiment of the present disclosure;

FIG. 3A schematically illustrates a process for disposing a touch sensor film according to an embodiment of the present disclosure;

FIG. 3B schematically illustrates a process for disposing a touch sensor film according to another embodiment of the present disclosure;

FIG. 3C schematically illustrates a resulting inner supporting frame with a touch sensor film disposed thereon according to an embodiment of the present disclosure;

FIG. 3D schematically illustrates an operation for assembling an outer housing and the inner support model according to an embodiment of the present disclosure;

FIG. 4 schematically illustrates a partial sectional view of an exemplary electronic device produced

FIG. 5A and 5B schematically illustrate front side and back side of an exemplary electronic device produced according an embodiment of the present disclosure.

### DETAILED DESCRIPTION OF EMBODIMENTS

Hereinafter, embodiments of the present disclosure will be described in details through embodiments with reference to the accompanying drawings. It should be appreciated that, while this specification contains many specific implementation details, these details should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Generally, all terms used in the claims are to be interpreted according to their ordinary meaning in the technical field, unless explicitly defined otherwise herein. All references to “a/an/the/said [element, device, component, means, step, etc]” are to be interpreted openly as referring to at least one instance of said element, device, component, means, unit, step, etc., without excluding a plurality of such devices, components, means, units, steps, etc., unless explicitly stated otherwise.

Hereinafter, reference will made to the accompany drawings to describe a method for producing an electronic device and an electronic device thus produced according to exemplary embodiments of the present disclosure.

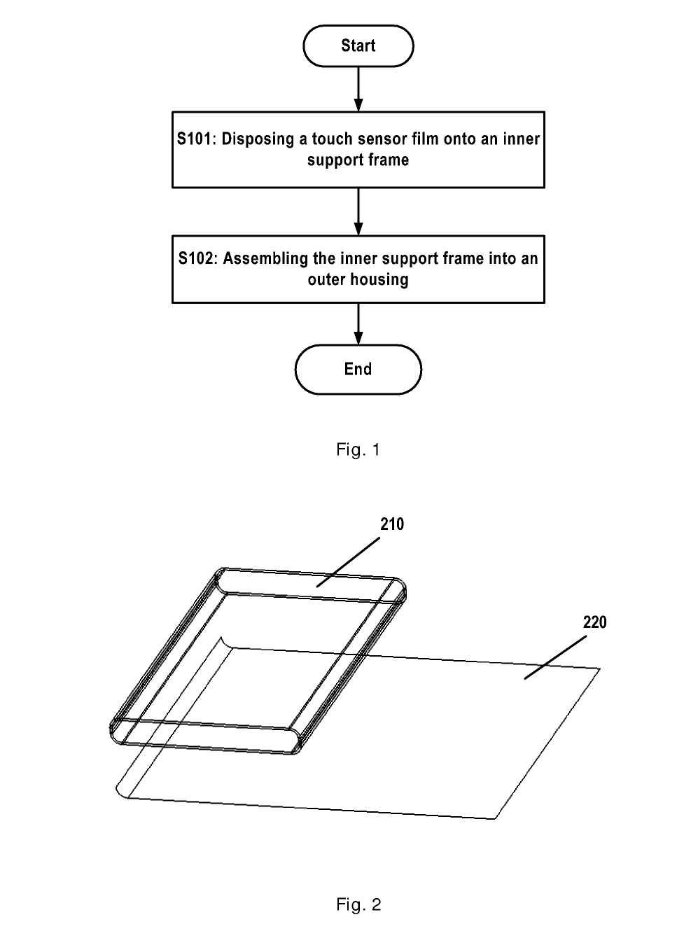

Reference is first made to FIG. 1, which schematically illustrates a flow chart of a method for producing an electronic device according to an embodiment of the present disclosure.

As illustrated in FIG. 1, first at step S101, a touch sensor film is disposed onto an inner supporting frame. For a full-touch electronic device, which is designed to provide touch sensing on all of its surfaces, the arrangement of the touch sensor film will be a challenging task since the touch sensor film is thin, flexible and fragile and thus easy to be damaged, such as being broken, wrinkled, etc. Besides, it is also easy to be damaged when a user scratches it. To address the problem, the inventors conceive a new approach of arranging the sensor film, i.e., providing an inner supporting frame in the electric device so that the touch sensor film can be easily attached thereon.

Reference is made to FIG. 2 which schematically illustrates a main idea of arrangement of a touch sensor film according to an embodiment of the present disclosure. As illustrated in FIG. 2, there is provided an inner supporting frame 210, the touch sensor 220 in a form of film, i.e., the touch sensor film, may be attached onto the surface of the inner supporting frame 210. It may be appreciated that it will be easier to attach the touch sensor film onto the outer surface of the inner supporting frame 210 with a substantially reduced risk of damaging the touch sensor film

The inner supporting frame 210 may be an integral component or a multi-part component including at least two separated parts which can be assembled together. The inner supporting frame 210 may be formed optically transparent (or at least semi-transparent) material such as glass, plastic cement, etc. The inner supporting frame 210 can be all optically transparent on the entire outer surface, which means it is possible to provide touch sensing on every location of the touch sensor film. Or alternatively, it may be partially transparent, for example, only areas designed to provide touch input (e.g., areas corresponding to a display window or areas corresponding to touch icons) are transparent while other areas may be formed of opaque material, such as metal, etc. Beside, it is also possible for the inner supporting frame 210 to be formed by other opaque materials; or in other words, the inner supporting frame 210 may be opaque completely, for example, in a case that areas for displaying are not covered by the inner supporting frame 210. As an example, the display may be in a form of a flexible display, which may be already disposed around the inner supporting frame before the touch sensor is disposed on the flexible display. In such a case, the inner supporting frame may be opaque or not.

However, for a convenience of description, the inner supporting frame 210 is considered to be fully formed of transparent (or at least semi-transparent) material.

Furthermore, the inner supporting frame 210 may be in a shape of tube. The shape of tube means a shape that may be formed from an extrusion or extrusion-like process. Or in other word, the shape of tube will have the exactly same one cross section along the length of the tube. Due to the uniform of the cross sections, which means there are no irregular convexes or concaves, the touch film will be more easily to be attached onto the inner support frame 210. Besides, the inner supporting frame 210 may be preferably shaped to have an outer surface with smooth transitions in such way the edges of the outer surface may be not too sharp, which will facilitate the attachment of the touch sensor film. In an embodiment of the present disclosure, the surface of the inner supporting frame may have rounded edges, For example, the surface may have a rectangular cross section, an elliptical cross section of a large aspect ratio or any other suitable shape. The inner supporting frame 210 is provided for ease of arrangement of the touch sensor film and thus for a view of size and weight of the electric device, the inner supporting frame 210 may be formed with a small thickness as long as it is suitable to support the touch sensor and easy to produce.

The inner supporting frame 210 may be formed by means of any suitable process which is already known in the art, such as an extrusion or extrusion-like process, or various popular molding technologies. For a purpose of not obscuring the present disclosure, the detailed process of producing such an inner supporting frame 210 will not be elaborated herein.

The attachment of the touch sensor film 220 may be implemented by various processes. Hereinafter only for a purpose of illustration, several example approaches will be described; however, it can be appreciated that the present disclosure is not limited thereon and there can be other means which are also suitable for attachment of the touch sensor film 220.

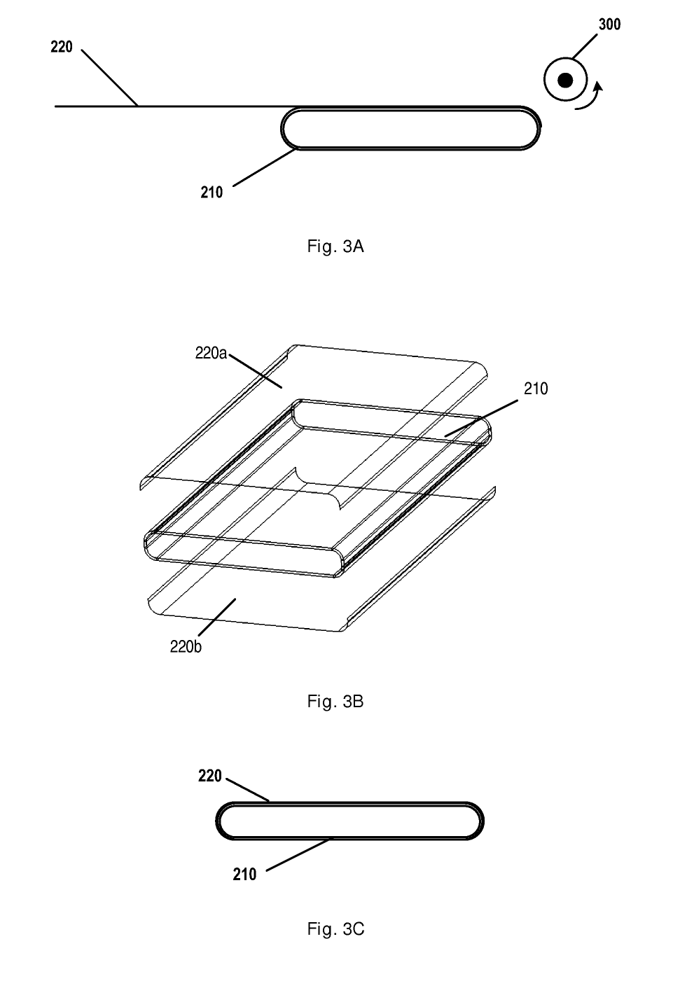

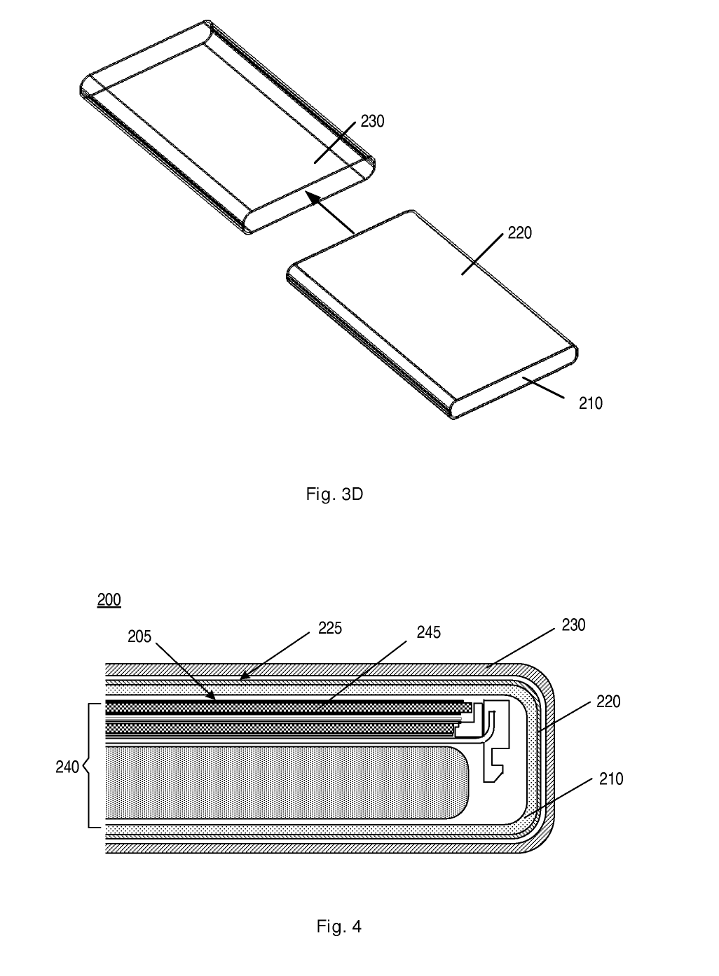

Referring to FIG. 3A, in an embodiment of the present disclosure, the touch sensor film 220 may be attached onto the inner supporting frame 210 by means of a lamination process. As illustrated in FIG. 3A, the inner supporting frame 210 may be fixed in place by a clamp apparatus (not shown), and at the same time, the touch senor film 220 may be positioned in place by positioning components as provided by the clamp apparatus (e.g., two posts) and corresponding holes as provided in a redundant portion in the touch sensor film 200. After that, a roller 300 which is activated by a motor and controlled under a controller may be driven to move along the outer surface of the inner supporting frame 210 such that the touch sensor film 200 may be well attached onto the outer surface of the inner supporting frame 210 without any air bubbles left therein.

FIG. 3B further illustrates an approach for disposing a touch sensor film according to another embodiment of the present disclosure, which is based on Inner Mode Label (IML) technology. As illustrated in FIG. 3B, first the touch sensor film should be cut into suitable size and shape, for example, two separate parts 220a and 220b, then the two separate parts 220a and 220b may be placed into a mold designed to mold the inner supporting frame 210, particular attached to inner surface of the mold. After that it may start the molding of the inner supporting frame 210. By means of such a molding process, the resulting inner supporting frame 210 will have the touch sensor film attached thereon when the molding is completed. However, it may be appreciated that although in the embodiment of the present disclosure, the touch sensor film 220 is described to be formed of two separate parts 220a and 220b, the present disclosure is not limited thereon, and the touch sensor film 220 may be an integral film or includes more than two parts. In a case of more than one part, program may be designed so as to butt edges of different parts well.

Accordingly, by means of manners such as those illustrated in FIG. 3A and 3B, the touch sensor film 220 may be easily attached onto the outer surface of the inner supporting frame 210 with a substantially reduced risk of being damaged, even without any damage. FIG. 3C illustrates a schematic diagram of a resulting inner supporting frame 210 with a touch sensor film 220 attached thereon. From FIG. 3C, it is clear that the touch sensor film 220 is attached onto the inner supporting frame 210 around the surface of the inner supporting frame 210.

Additionally, it should be also noted that, in the inner supporting frame 210 are enclosed inner electronic components of the electronic device including a display device such as liquid crystal display (LCD). The inner electronic components may be secured onto a base plate, and they may be enclosed into the inner supporting frame 210, for example, after the touch sensor film 210 has been attached onto the inner supporting frame 210. In addition, the inner electronic components may also be enclosed into the inner supporting frame 210 before the touch sensor film 220 is attached thereon, for example when the attachment is implemented by the lamination process.

Next, referring back to FIG. 2, then at step S201, the inner supporting frame 210 may be assembled into an outer transparent housing 230. To explain operations of the step in more detail, reference will be further made to FIG. 3D, which schematically illustrates a process for assembling an outer housing and the inner support model according to an embodiment of the present disclosure. After enclosing the inner electronic devices into the inner supporting frame 210, the inner supporting frame 210 may be put into an outer housing so as to assemble them together, as illustrated in FIG. 3D. In such a way, it could provide a protection for the sensor touch so that it is not easy to be damaged even when the surface of the electronic device is scratched or subjected to other outside force.

The outer housing 230 has a substantially similar shape to that of the inner supporting frame 210. In such a way, the outer housing 230 can be well matched with the inner supporting frame 210. However it should be appreciated that the outer housing 230 may also be shaped to any other suitable shape which is somewhat different from that of the inner supporting frame 210. The touch sensor film whose sensitivity may be adjusted was already known and thus the sensitivity of the touch sensor film may be adjusted accordingly so that the touch sensor film could be activated by a user's touching of the outer surface of the outer housing or even if their finger is above the surface of the outer surface i.e. hovering above the surface or in close proximity to the surface. In such a case, it will be advantageous if the outer housing 230 has a substantially similar shape to that of the inner supporting frame 210, since the air gap between the outer housing 230 and the inner supporting frame 210 may be even, which will simplify adjustment of sensitivity. While it might be more complex to adjust the sensitivity if they have different shapes. It is appreciated that the term “activated” can mean an action i.e. interacting with the touch sensor, which results in a change in the content of the display or a change in an audio of visual property of the electronic device.

In addition, similarly to the inner supporting frame 210, the outer housing 230 may also be an integral component or a multi-part component including at least two separated parts which can be assembled together. The outer housing 230 may be formed optically transparent (or at least semi-transparent) material such as glass, plastic cement, etc. The outer housing 230 can be optically transparent on the entire outer surface, which means it is possible to provide touch sensing on every location of the touch sensor film. Or alternatively, it may be partially transparent, for example, the outer housing 230 may be only transparent on areas that are designed to provide touch input while other area may be opaque. The outer housing 210 may be formed by means of any suitable process which is already known in the art, such as various an extrusion or extrusion-like process, or other popular molding technologies. For a purpose of not obscuring the present disclosure, the detailed process of producing the outer housing 230 will not be elaborated herein.

With embodiments of the present disclosure, the touch sensor film 200, which is fragile, flexible and easy to be broken or wrinkled, can be easily integrated into the electronic device without being damaged. Accordingly, according to embodiments of the present disclosure, a nearly full touch electronic device can be achieved.

FIG. 4 illustrates a partial sectional view of an exemplary electronic device produced according an embodiment of the present disclosure. As illustrated in FIG. 4, at the outmost side of the electronic is the outer housing 230 for receiving the inner supporting frame 210 on which touch sensor film 220 is disposed. In the inner supporting frame 210 are enclosed inner electronic components 240 including the displaying device 245 such as a LCD display.

Besides, it may noted that between the outer housing 230 and the inner supporting frame 210 (more specifically, the touch senor film 220), there might be a small air gap 225. However, it may be noted that the effect of the gap 225 on touch functionality may be overcome by adjusting the display sensitivity. Moreover, it is known that close distance air touch was already available on the market. Therefore, it will have no adverse impact on the touch functionality. Besides, to optimize the visual effect, a polarizer which is commercially available on the market may be arranged here so that the thickness of the outer housing can not be noticed by the user. Alternatively, a polarizer may also be interposed in the air gap 225. These are already known solutions in the prior art and thus will not be detailed herein for a purpose of simplification of the description.

Additionally, as illustrated in FIG. 4, another gap 205 may also exist between the inner supporting frame 210 and the inner electronic device 240 (more specifically the LCD display 245). Due to the fact that the touch sensor film 220 is located on the outer surface or the inner supporting frame 210, this air gap 205 will not have any impact on touch functionality of the touch sensor film at all. On the other hand, to achieve a better visual effect, similarly to the air gap 205, a further liquid-OCA or a further polarizer may be placed in the air gap 205.

In such a way, any possible problems that might be caused from these gaps can be well tackled. That is to say, it is feasible for the solution as proposed in embodiments of the present disclosure to be used wildly in electronic device manufacturing.

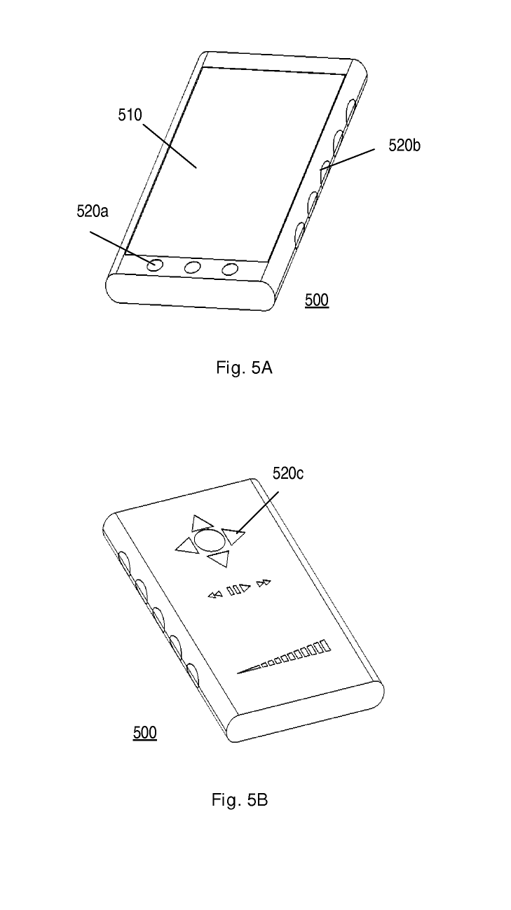

For a purpose of illustration, FIGS. 5A and FIG. 5B schematically illustrate front side and back side of an exemplary electronic device produced according an embodiment of the present disclosure, which may comprise a display window and a polarity of icons which can be activated by touching. As illustrated in FIG. 5A, on the front side of the electronic device 500, it may comprise a display window 510 for displaying image, picture, and other information just like common display window. Besides, the electronic device 500 may also comprise a plurality of icons 520a on the front surface, for example acting as home key, menu key, return key, and so on, but they are touch icons. Moreover, on two sides of the electronic device 500, there may also provide a plurality of touch icons 520b for example acting as a power key, mute key and so on. While on the back side of the electronic device, it may also provide further touch icons, such as for navigating, controlling audio or video playing, controlling the volume of sound and so on.

It may be appreciated that in the illustrated electronic device 500, the touch functionality is provided on four main surfaces of the electronic device. However, it may be appreciated it may also be possible to dispose the touch sensor film on the entire surface of the inner supporting frame 210.

In addition, it may be appreciated that in FIG. 5, the example electronic device is illustrated as a smart phone. However, the present disclosure is not limited thereto and actually, the electronic device may also include any other kinds of electronic devices such as such as tablet devices, electronic book readers, and so on.

Hereinabove, reference has been made to specific embodiments of the present disclosure to describe the solution as provided in the present disclosure. However, it may be appreciated that these embodiments are provided only for a purpose of illustration and the present disclosure is not limited thereto. For example, in embodiments of the present invention, the touch sensor film is described as covering at least four main surfaces of the inner supporting frame 210 with two ends being exposed; however, it may be understood that it is also possible to cover all surfaces of the inner supporting frame 210. In addition, although embodiments of the present disclosure are especially suited for the electric device in a uni-body design, but it is not limited thereto and it may be used in other electronic devices in any other designs.

Various modifications, adaptations to the foregoing exemplary embodiments of this disclosure may become apparent to those skilled in the relevant arts in view of the foregoing description, when read in conjunction with the accompanying drawings. Any and all modifications will still fall within the scope of the non-limiting and exemplary embodiments of this disclosure. Furthermore, other embodiments of the disclosures set forth herein will come to mind to one skilled in the art to which these embodiments of the disclosure pertain having the benefit of the teachings presented in the foregoing descriptions and the associated drawings.

Therefore, it is to be understood that the embodiments of the disclosure are not to be limited to the specific embodiments disclosed and that modifications and other embodiments are intended to be included within the scope of the appended claims. Although specific terms are used herein, they are used in a generic and descriptive sense only and not for purposes of limitation.

1-17. (canceled)

18. A method for producing an electronic device, comprising:
disposing a touch sensor in a form of film onto an outer surface of an inner supporting frame; and
assembling the inner supporting frame into an outer housing which is at least partially transparent, wherein the touch sensor is configured so that it can be activated by interaction with a surface of the outer housing.

19. The method according to claim 18, wherein the inner supporting frame is in a shape of tube.

20. The method according to claim 18, wherein the inner supporting frame is shaped to have an outer surface with smooth transitions.

21. The method according to claim 18, wherein the outer housing is in a shape substantially similar to that of the inner supporting frame.

22. The method according to claim 18, further comprising:
before assembling the inner supporting frame into the outer housing, enclosing inner electronic components including a display inside the inner supporting frame with a liquid optical clear adhesive or a polarizer disposed in a gap between the inner supporting frame and the display, wherein the inner supporting frame is at least partially transparent.

23. The method according to claim 18, further comprising:
disposing a flexible display around the inner supporting frame before disposing the touch sensor.

24. The method according to claim 18, further comprising:
disposing a further liquid optical clear adhesive or a further polarizer in a gap between the inner supporting frame and the outer housing.

25. The method according to claim 18, wherein the touch sensor is disposed on the inner supporting frame through any one of a lamination process and an inner mode label process.

26. The method according to claim 18, wherein the interaction may be any one of:
touching a surface of the outer housing,
user interaction in close proximity to the surface of the outer housing,
a user's finger hovering above the surface of the outer housing.

27. An electronic device, comprising
an inner supporting frame with a touch sensor in a form of film disposed thereon; and
an outer housing which is at least partially transparent and surrounds the inner supporting frame, wherein the touch sensor is configured so that it can be activated by interaction with a surface of the outer housing.

28. The electronic device according to claim 27, wherein the inner supporting frame is in a shape of tube.

29. The electronic device according to claim 27, wherein the inner supporting frame has an outer surface with smooth transitions.

30. The electronic device according to claim 27, wherein the outer housing is in a shape substantially similar to that of the inner supporting frame.

31. The electronic device according to claim 27, wherein the inner supporting frame is further configured to enclose inner electronic components including a display and wherein a liquid optical clear adhesive or a polarizer is disposed in a gap between the inner supporting frame and the display.

32. The electronic device according to claim 27, further comprising a flexible display which is located between the inner supporting frame and the touch sensor and around at least part of the inner supporting frame.

33. The electronic device according to claim 27, wherein a further liquid optical clear adhesive or a further polarizer is disposed in a gap between the inner supporting frame and the outer housing.

34. The electronic device according to claim 27 wherein the interaction may be any one of:
touching a surface of the outer housing,
user interaction in close proximity to the surface of the outer housing,
a user's finger hovering above the surface of the outer housing.
